(19) United States
(12) Patent Application Publication
(10) Pub. No.: US 2018/0136072 A1
(43) Pub. Date: May 17, 2018

(54) GAS DETECTION, IMAGING AND FLOW RATE MEASUREMENT SYSTEM

(71) Applicant: CI SYSTEMS (ISRAEL) LTD., MIGDAL HA'EMEK (IL)

(72) Inventor: Dario CABIB, Timrat (IL)

(21) Appl. No.: 15/737,286

(22) PCT Filed: Jun. 16, 2016
(86) PCT No.: PCT/IL2016/050634

§ 371 Date: Dec. 17, 2017

Related U.S. Application Data
(60) Provisional application No. 62/193,102, filed on Jul. 16, 2015.

(51) Int. Cl. G01M 3/04; G01S 17/08; G01N 21/3504

(52) U.S. Cl. CPC G01M 3/04; G01N 21/3504; G01S 17/08

(57) ABSTRACT

A system analyzes radiation from a scene in a field of view that includes a gas cloud with absorption characteristics in a wavelength band. The system includes first and second devices. The first device includes a detector and produces pixel signals that include information associated with absorption of radiation in the gas cloud wavelength band. An image of the scene is formed on the detector based on the pixel signals. A non-predetermined region of the scene within the field of view in which the gas cloud is present is identified based on the pixel signals. The second device includes a detector and a lens, and receives the identified region of the scene. The system determines a distance between the identified region of the scene and the system based on the lens focus relative to the identified region of the scene in an image formed on the detector by the lens.

### CROSS-REFERENCE TO RELATED APPLICATIONS

This application claims priority from U.S. Provisional Patent Application No. 62/193,102, filed Jul. 16, 2015, whose disclosure is incorporated by reference in its entirety herein.

### TECHNICAL FIELD

The present invention relates to the detection, imaging and measurement of infrared radiation.

### BACKGROUND OF THE INVENTION

The detection and quantitative measurement of gas leaks in various settings, such as, for example, industrial installations, is of great importance. Such detection and quantification may aide in the control and monitoring of greenhouse gases, uphold safety regulations, determine how hazardous gases are dealt with, and may have general economic implications, such as, for example, potential financial losses due to a gas leak in a production plant.

Upon detection of a gas leak, the amount of gas lost per unit time (i.e., the leak flow rate) may be a contributing factor in deciding as to what action should be taken as a result of the detection. In many instances, tradeoffs between timing and costs may be considered before fixing a gas leak, based on the magnitude of the leak.

At present, various types of gas leak detection methods exist. A common leak detection method of liquid petroleum type gases (e.g., propane and butane) is based on the human sense of smell when used in home settings, but requires mixing with other gases as propane and butane are odorless and cannot be detected by smell alone. Furthermore, such detection methods are obviously not suitable to industrial situations and for quantitative estimations. Other methods are based on portable instruments which can be mobilized and exposed to suspect locations, such as for example sites of accidents involving gas transporting trucks. Such instruments typically contain materials that react chemically with the gas to be detected, and provide an alarm when such reaction takes place. However, such instruments require manual positioning proximate to the gas region by a person, which can subject the person to a high risk of intoxication by hazardous gases. In addition, in industrial settings, where a large number of pipes are prone to develop leaks and are required by regulatory laws to be inspected periodically, human manual positioning and operation is manpower intensive and very expensive.

Recent years have seen developments in the field of infrared imaging for detection, identification, and quantification of hazardous gas leaks and clouds using spectroscopic remote sensing methods. This has been motivated by several facts, some of which are: i) gases absorb specific infrared wavelengths and are detectable by infrared camera systems when they are combined with appropriate spectral filters, ii) infrared camera systems are becoming more affordable and accurate, and can be used as radiation measuring tools providing quantitative information at every pixel of a scene, and iii) the hazard to a human operator is reduced, due to the remote operation capability of such camera systems.

However, although such remote sensing systems are able to detect and image hazardous gas leaks and clouds invisible to the naked eye, they provide only partial quantitative information. A remote sensing measurement of a cloud of gas at an unknown distance from an observer can provide only a surface density of gas molecules at each pixel of the image as seen by the camera. The surface density on a pixel area at the cloud is equivalent to the integral of the gas concentration over the path of the radiation through the cloud, reaching the corresponding detector element of the camera. Such an integral may be referred to in the literature as the “path concentration of the cloud”, the “concentration time path length” of the cloud, or the “gas column density”.

Once the path concentration of the gas cloud is known for every pixel in the cloud, one way of estimating the amount of gas (in weight or number of molecules) present in a cloud volume or the amount of gas molecules flowing in a leak per unit time, is to estimate of the distance between the camera system and the cloud or leak itself. This is due to the fact that if both the surface density and the pixel surface area on the cloud are known, then one can calculate the quantity of gas matter present. As a matter of fact, the pixel angular size is known from the camera system properties, but without the knowledge of the distance from the cloud, the size cannot be translated to a pixel physical area. This is not a fundamental problem when the potential leak source is known and the camera is in a fixed position and always aligned on the gas exit location (or exit point), since the distance can be easily known in advance (for example by triangulation or mapping measurements performed at an installation) and can be used as input in the relevant algorithms. This is for example the case when measuring the amount of gas flowing from a smokestack, in which the gas exit location is known a priori. However, the distance to a gas cloud is usually not known in many other situations, such as, for example, when a hand held camera is used to scan a wide area in an industrial plant with a large number of potentially leaking pipes. In such situations, when one leak is found in an image, the operator has usually no knowledge of his/her distance from it.

### SUMMARY OF THE INVENTION

The present invention is directed to systems and devices for analyzing gas clouds by performing operations to detect and imaging such gas clouds, to measure (e.g., estimate) the distance to the gas and the geographical location from which the gas cloud exits, and measure parameters of the gas, such as, for example, the gas path concentration and flow rate of the gas. The systems and devices are deployable in a wide range of locations and can be transported and operated in such locations without a priori knowledge of locations of potential gas cloud exit points or distances to those exit points from the systems and devices.

According to an embodiment of the teachings of the present invention there is provided, a system for analyzing radiation from a scene that includes a gas cloud having absorption characteristics in a corresponding wavelength band. The system comprises: an optical device for detecting and imaging the radiation from the scene, the optical device having a first field of view and including a first detector having a plurality of detector elements, each detector element associated with a corresponding scene pixel, the optical device configured to: produce a pixel signal from each respective detector element, each of the pixel signals including information associated with the absorption of radiation in the wavelength band of the gas cloud, form an image of the scene on the first detector based on the produced pixel signals, and identify a non-predetermined region of the scene within the first field of view in which the gas cloud is present based on the produced pixel signals; and a distance measuring device operative to receive input from the optical device, the distance measuring device including a second detector of the scene and an optical collection system that includes at least one lens for forming an image of the scene on the second detector, the optical collection system having a second field of view having at least partial overlap with the first field of view, the distance measuring device configured to: receive the identified region of the scene from the optical device, and determine a distance between the identified region of the scene and the system based on the focus of the at least one lens relative to the identified region of the scene in the image formed on the second detector by the optical collection system.

Optionally, the gas cloud emanates from a source location, and the identified region of the scene includes at least one of the source location or an object in a vicinity of the source location.

Optionally, the distance measuring device further includes a processing unit for determining the distance between the identified region of the scene and the system.

Optionally, the optical device further includes: an image forming optical component for forming an image of the scene on the elements of the first detector; and electronic circuitry electronically coupled to the first detector, the electronic circuitry configured to: produce the pixel signals from each respective detector element, identify the region of the scene in which the gas cloud is present, and provide the identified region of the scene to the distance measuring device.

Optionally, the electronic circuitry is further configured to: receive the determined distance as input from the distance measuring device.

Optionally, the distance measuring device further includes a processing unit for determining the distance between the identified region of the scene and the system, and at least one of the processing unit or the electronic circuitry is configured to determine a measurement parameter of the gas cloud based on the determined distance.

Optionally, the measurement parameter is selected from the group consisting of: a path concentration of the gas cloud in each pixel of the image formed on the first detector, a column density of the gas cloud, a surface density of the gas cloud, an amount of gas molecules that are present in each column of the gas cloud, an amount of gas molecules present in the gas cloud, a flow rate of the gas cloud, and a combination thereof.

Optionally, the processing unit is configured to: provide the determined distance to the electronic circuitry.

Optionally, the processing unit and the image acquisition electronics are implemented as a single processing system having at least one processor.

Optionally, the second detector is positioned along the optical axis of the image forming optical component.

Optionally, the at least one lens has an adjustable focus, and the determined distance is based on at least one of the amount of adjusted focus required to bring the identified region of the scene into focus, or the position of the focusing lens when the scene is in focus.

Optionally, the system further comprises: a mechanism for adjusting the focus of the at least one lens.

Optionally, the at least one lens is permanently focused at a fixed distance, and the determined distance is based in part on each of the fixed distance and the amount of distortion and/or image blur in the identified region of the scene.

Optionally, the first detector is sensitive to radiation in a plurality of wavelength bands, and the system further comprises:

Optionally, the system further comprises: a filtering arrangement including a filter associated with the corresponding wavelength band.

Optionally, the first detector is sensitive to radiation in a plurality of wavelength bands, and the filtering arrangement includes a plurality of filters, each of the filters being associated with a different wavelength band.

Optionally, the system further comprises: a mechanism operative to alternately and reversibly position each of the filters at a focal plane between the scene and the first detector.

Optionally, the optical device and the distance measuring device are retained within a common housing.

There is also provided according to an embodiment of the teachings of the present invention, a system for analyzing radiation from a scene that includes a gas cloud emanating from a source location, the emanating gas cloud having absorption characteristics in a corresponding wavelength band. The system comprises: a detector of the radiation from the scene, the detector including a plurality of detector elements, each detector element associated with a corresponding scene pixel; an image forming optical component for forming an image of the gas cloud on the elements of the detector; a distance measuring device including a laser emitter and a controller for actuating the laser emitter to emit at least one laser pulse; and

Optionally, electronic circuitry electronically coupled to the detector and operative to provide input to the laser unit, the electronic circuitry configured to: produce a pixel signal from each respective detector element, each of the pixel signals including information associated with the absorption of radiation in the wavelength band of the gas cloud, identify a region of the scene for which the gas cloud is present based on the produced pixel signals, the identified region of the scene including the source location, and provide to the distance measuring device a pointing direction for directing the at least one laser pulse toward the source location to determine a distance between the identified region of the scene and the system.

Optionally, the scene is selected from a non-predetermined geographic location within a field of view defined by the image forming optical component.

Optionally, the system further comprises: a mechanism functionally associated with the controller configured to direct the at least one laser pulse.

Optionally, the electronic circuitry is operatively coupled to the controller and is further configured to: provide a command to the controller to actuate the mechanism to direct the at least one laser pulse toward the identified region of the scene.

Optionally, the system further comprises: a filtering arrangement including a filter associated with the corresponding wavelength band.

Optionally, the detector is sensitive to radiation in a plurality of wavelength bands, and the filtering arrangement includes a plurality of filters, each of the filters being associated with a different wavelength band.

Optionally, the system further comprises: a mechanism operative to alternately and reversibly position each of the filters at a focal plane between the scene and the detector.

Optionally, the image acquisition electronics and the controller are implemented as a single processing system having at least one processor.

Optionally, the detector, the image forming optical component, the electronic circuitry, and the distance measuring device are retained within a common housing.

There is also provided according to an embodiment of the teachings of the present invention, a device for analyzing radiation from a scene that includes a gas cloud having absorption characteristics in a corresponding wavelength band. The device comprises: a detector of the radiation from the scene, the detector including a plurality of detector elements, each detector element associated with a corresponding scene pixel; a filtering arrangement including a filter associated with the corresponding wavelength band; an optical collection system including at least one lens having adjustable focus for forming an image of the scene on the elements of the detector; and electronic circuitry electronically coupled to the detector, the electronic circuitry configured to: produce a pixel signal from each respective detector element, each of the pixel signals including information associated with the absorption of radiation in the wavelength band of the gas cloud, identify a non-predetermined region of the scene within a field of view defined by the optical collection system in which the gas cloud is present based on the produced pixel signals, and determine a distance between the identified region of the scene and the device based on the amount of adjusted focus of the at least one lens required to bring the identified region of the formed image of the scene into focus.

Optionally, the device further comprises: a mechanism for adjusting the focus of the at least one lens, and wherein the electronic circuitry is further configured to actuate the mechanism to adjust the focus of the at least one lens.

Optionally, the gas cloud emanates from a source location, and the identified region of the scene includes the source location.

There is also provided according to an embodiment of the teachings of the present invention, a distance measuring device having a field of view. The distance measuring device comprises: a detector of a scene within the field of view, the scene being selected from a non-predetermined geographical location; an optical collection system including at least one lens for forming an image of the scene on the detector, the optical collection system defining the field of view of the distance measuring device; and a processing unit for receiving as input a location in an image of the scene, the location including at least one of a point of emanation of a gas cloud or an object in a vicinity of the point of emanation of the gas cloud the processing unit configured to: determine a distance between the gas cloud and the distance measuring device based on the focus of the at least one lens relative to the location in the image of the scene formed on the detector by the optical collection system.

### BRIEF DESCRIPTION OF THE DRAWINGS

The invention is herein described, by way of example only, with reference to the accompanying drawings, wherein:

FIG. 1 is a schematic illustration of an environment in which a system for detecting, imaging, and measuring the flow rate of a gas is deployed according to an embodiment of the invention;

FIG. 2 is a schematic illustration of a gas detection and imaging device of the system according to an embodiment of the invention;

FIG. 3 is a schematic illustration of a distance measuring device of the system according to an embodiment of the invention;

FIG. 4 is a block diagram of image acquisition electronics coupled to a detector array of the gas detection and imaging device according to an embodiment of the invention;

FIG. 5 is a processing unit coupled to the detector array of the gas distance measuring device and the image acquisition electronics according to an embodiment of the invention;

FIG. 6 is a block diagram of a distance measuring device coupled to the image acquisition electronics according to an embodiment of the invention;

FIG. 7 is a schematic illustration of a system for detecting, imaging, and measuring the flow rate of a gas, deployed in a single device according to an embodiment of the invention; and

FIG. 8 is a plot of lens position sensitivity (in millimeters) versus the distance from a gas leak (in meters) for different lens focal lengths.

### DESCRIPTION OF THE PREFERRED EMBODIMENTS

The present invention is directed to systems and devices for detecting and imaging a gas cloud, measuring (e.g., estimating) the distance between such systems and devices and the gas, and for measuring parameters of the gas (e.g., the gas path concentration and flow rate of the gas). The principles and operation of the systems and devices according to the present invention may be better understood with reference to the drawings and the accompanying description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

In order to better understand the embodiments of the invention, mathematical relations for calculating the surface density on a pixel area at the cloud are first described in detail below. Note that such mathematical relations are derived from radiative transfer models which should be known to those of ordinary skill in the art.

### 1. Gas Measurement:

Detection of the presence (or absence) of a gas in the air is possible by measuring, using a camera system having a detector, the infrared self-emission of the background of the gas cloud in two different wavelengths, one which is absorbed by the gas and one which is not, provided that the background and gas are at different temperatures.

Under the assumption of 100% transmittance in an atmospheric spectral window, the spectral radiance R(λ) received by a detector (e.g., a photodetector array) is a function of the background radiance R_{B}(λ), the gas cloud radiance R_{G}(λ), and the parameters k(λ) and p(x,y,z). The parameter k(λ) is the wavelength λdependent molecular absorption cross section function of the gas in units of area, and the parameter p(x,y,z) is the gas density field, in units of number of molecules per unit volume. Note that the x coordinate is the optical axis of the camera system. The spectral radiance R(λ) can thus be expressed as follows:

R(λ)=R_{G}(λ)+[R_{B}(λ)−R_{G}(λ)]*exp[−k(λ)*∫ρ(x,y,z)dx] (1)

The integral in the exponent of equation (1) is calculated along the path between the background and the camera system in the direction of optical axis of the camera system. If the background is warmer than the gas in the air, R(λ) appears as an absorption spectrum with minima at the gas absorption wavelengths. If the background is cooler than the air, then R(λ) appears as an emission spectrum with maxima at the gas absorption wavelengths. Accordingly, the integral in the exponent of equation (1) can be interpreted as an average of ρ(x,y,z) along the path, which can be expressed as a function ρ′(y,z) of y and z, multiplied by a path t(y,z) in units of length. The units of ρ′(y,z) are number of molecules per unit surface of the gas cloud pixel of coordinates (y,z) as seen by the camera. As such, equation (1) can be written as:

R(λ)=R_{G}(λ)+[R_{B}(λ)−R_{G}(λ)]*exp[−k(λ)*ρ′(y,z)*t(y,z)] (2)

The radiances R_{G}(λ) and R_{B}(λ) can be approximated by the Planck functions P(T_{G},λ) and P(T_{B},λ) at the air and background temperatures, T_{G} and T_{B}, respectively.

If the detector of the camera system is calibrated to measure the radiance R(λ) in the absence and presence of gas, and λ is matched to an absorption wavelength of the gas to be detected, the difference between the two measurements can be used to find the quantity ρ′(y,z)*t(y,z), the so called path concentration of the gas in question (as defined previously). For simplicity, the coordinates (y,z) are henceforth omitted from both ρ′ and t, since the equations are valid for each pixel independently.

In fact, in the absence of gas k(λ)=0, and equation (2) becomes:

R_{no gas}(λ)=R_{B}(λ) (3)

and in the presence of gas equation (2) holds, so the difference between the two measurements can be expressed as:

R_{no gas}(λ)−R(λ)=R_{B}(λ)−R(λ)=[R_{B}(λ)−R_{G}(λ)]*[1−exp[−k(λ)*ρ′*t]]=[R_{B}(λ)−P(T_{G},λ)]*[1−exp[−k(λ)*ρ′t]] (4)

The quantity T_{G} in equation (4) can be measured by a thermometer positioned near the camera system, and is typically assumed to be at the same temperature as the gas cloud. The quantity R_{B}(λ) in equation (4) is measured by equation (3). The quantity k(λ) can be determined by a priori measurements of gas absorption in a laboratory, or can be known from the literature. Accordingly, as a result, the quantity ρ′t can be calculated by:

exp[−k(λ)ρ′t]=1−[R_{B}(λ)−R(λ)]/[R_{B}(λ)−P(T_{G},λ)] (5)

which yields:

ρ′t=−1/k(λ)*ln{1−[R_{B}(λ)−R(λ)]/[R_{B}(λ)−P(T_{G},λ)]} (6)

As such, ρ′t can be measured since all parameters on the right hand side of equation (6) are either known from measurements made by the camera system or via a priori knowledge.

Note that from equation (6) the quantities ρ′ and t cannot be measured separately, but only as a resulting product. If ρ′ is expressed as an average volume density of number of molecules in the gas cloud along the path seen by a single detector element of the camera system, then the quantity ρ′t is equal to the average surface density of molecules N_{S} as seen by the detector element on the cross sectional area S of the beam reaching that particular detector element, as measured on the plane of the gas cloud (i.e., the pixel area on the cloud). In fact, if N is the total number of molecules involved in the interaction with the radiation in the beam reaching the detector element in question, for an approximately collimated beam, the total beam volume V can be expressed as:

V=St (7)

and the quantity ρ′t can be expressed as:

ρ′t=Nt/V=Nt/(St)=N/S=N_{S} (8)

In addition, if the field of view of the detector element is Ω steradian and the distance from the camera system to the cloud is L, the beam cross sectional area S can be approximated as:

S=Ω*L² (9)

Accordingly, from equations (8) and (9), N can be expressed as:

N=N_{S}*S=N_{S}*Ω*L²=ρ′t*Ω*L² (10)

As a result, the quantity N in the respective pixel cloud column can be known if L is known (or estimated). In fact, Ω is a property of the camera system and ρ′*t is measured from the procedure of equation (6) above. In the following sections, various embodiments of systems and devices will be presented for measuring the distance L and for measuring parameters of the gas, such as, for example, the quantity N and derivatives thereof, based on the measured distance L. Each of the embodiments allow for estimates of the distance L and other parameters of the gas to be determined from a location remote from the gas location. Furthermore, each of the embodiments do not require any a priori measurements of the distance between the system of the embodiments and the potential geographical locations of gas clouds. In other words, each of the embodiments, as will be presented in the subsequent sections of the present disclosure, can be placed in any installation in which a gas source may result in an emanating gas cloud without a priori distance measurements between the systems/devices and the gas source.

### 2. General Elements of the Embodiments of the Present Disclosure:

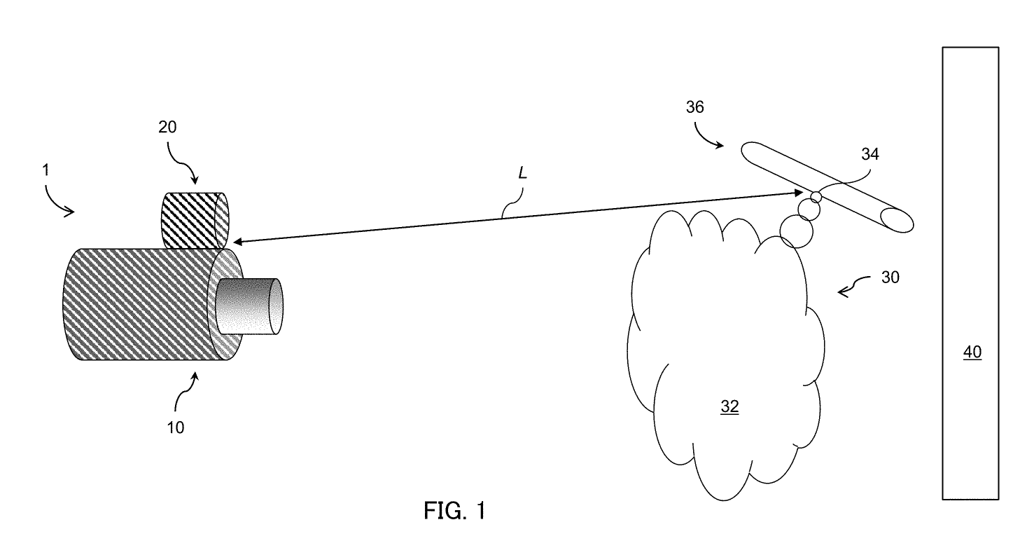

Refer now to FIG. 1, a schematic illustration of an embodiment of a system 1 of the present disclosure. The system 1 includes a detection and imaging device 10 and a distance measuring device 20. The system 1 is remotely operable, such that an operator of the system 1 is not required to be in the proximity of the system 1 to operate the system 1. The detection and imaging device 10 is operative to detect and image a scene 30 in the infrared region of the electromagnetic spectrum, against a background 40. The scene 30 is illustratively depicted in FIG. 1 as a gas cloud 32 emanating from a gas exit region 34 (i.e., a hole, crack or the like) in a pipe 36 or other similar type source.

The distance measuring device 20 is operative to measure (i.e., estimate) a distance L between the scene 30 and the system 1, and more specifically the distance between the gas exit region 34 or other object in the vicinity of the gas cloud 32 and the system 1. As will be discussed in more detail below, the system 1 is operative to measure parameters of the gas cloud 32 based on the detection and imaging information provided by the detection and imaging device 10 and the estimated distance L information provided by the distance measuring device 20.

It is noted that in certain non-limiting implementations, the components and subcomponents of the system 1 may be positioned and fixedly retained within a common casing or housing. In other words, in such non-limiting implementations, the detection and imaging device 10 and the distance measuring device 20 are fully contained within a common casing housing. Alternatively, the distance measuring device 20 may be deployed to operate with a pre-existing detection and imaging device, such as the detection and imaging device 10 as will be described below.

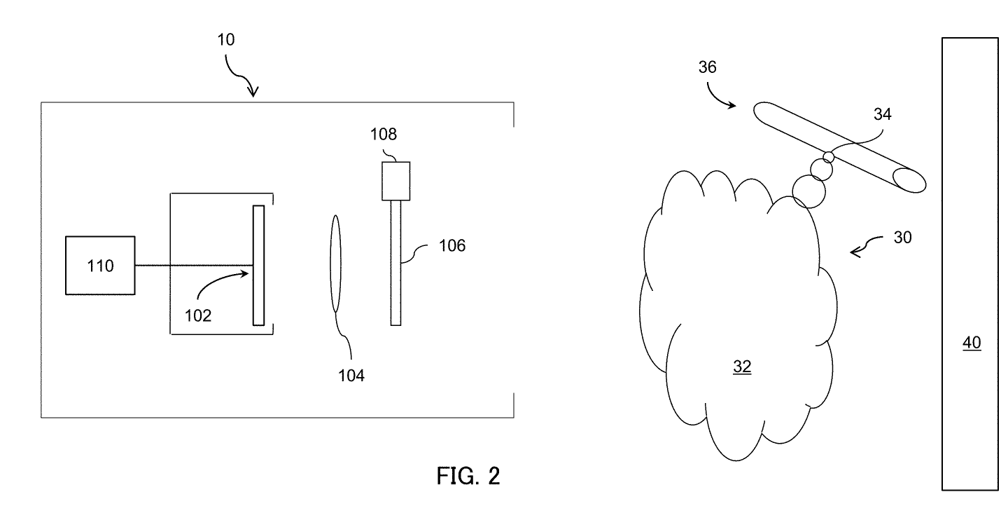

FIG. 2 depicts a schematic illustration of an embodiment of the detection and imaging device 10 operative to provide input to, and receive input from, the distance measuring device 20. The detection and imaging device 10 includes an infrared detector array 102, an image forming optic 104, a filtering arrangement 106, and a mechanism 108 for positioning the filtering arrangement 106 between the scene 30 and the detector array 102. The detection and imaging itself is done by the detector array 102, which although not shown, includes a plurality of detector elements corresponding to individual pixels of the imaged scene (i.e., scene pixels). The detector array 102 may be sensitive to radiation in portions of any or all of the Near Infrared (NIR), Short-Wave Infrared (SWIR), Mid-Wave Infrared (MWIR), and Long-Wave Infrared (LWIR) regions of the electromagnetic spectrum. In a non-limiting implementation, the detector array 102 may be implemented as an uncooled detector array, such as, for example, a microbolometer type array. In another non-limiting implementation, the detector array 102 may be implemented as a cryogenically cooled detector array positioned within a Dewar (not shown), or thermoelectrically cooled detector array.

The image forming optic 104 is represented symbolically in FIG. 2 by an objective lens, which may be a set of one or more lenses that is represented in FIG. 2 by a single lens. The image forming optic 104 defines a field of view (FOV) of the detection and imaging device 10, and directs radiation from the scene 30, within the defined FOV, onto the elements of the detector array 102 for forming an image of the scene 30 (e.g., the gas cloud 32) on the detector array 102.

The filtering arrangement 106 includes a filter, and preferably a plurality of interchangeable filters, each one adapted to different gas absorption wavelengths. As such, the detection and imaging device 10 is capable of performing detection and imaging of a variety of gases having spectral characteristics in different wavelength bands. The mechanism 108 may be implemented as a filter wheel or holder for retaining the filters of the filtering arrangement 106 and for alternately and reversibly positioning each individual filter between the scene 30 and the detector array 102. Although the image forming optic 104 is depicted as being positioned between the detector array 102 and the filtering arrangement 106, other implementations are possible, for example, in which the filtering arrangement 106 and the mechanism 108 are positioned between the image forming optic 104 and the detector array 102. Further still, the image forming optic 104 may include a re-imaging lens in addition to the objective lens, and the filtering arrangement 106 and the mechanism 108 may be positioned at an intermediate focal plane between such a re-imaging lens and objective lens.

Note that alternative optical and filtering configurations of detection and imaging devices are possible which may achieve the same or similar results as the detection and imaging device 10. In certain configurations, optical imaging and spectral filtering of the gas cloud radiation may be achieved without any movement of the filters in question.

In one example, a detection and imaging device may image the same scene simultaneously on different portions of a two-dimensional detector array after being filtered by appropriate spectral filters positioned relative to wedge-shaped optical components. The description and operation of such a detection and imaging device is disclosed in the applicants' commonly owned U.S. patent application, entitled “Dual Spectral Imager with No Moving Parts” (U.S. patent application Ser. No. 14/949,909), filed Nov. 24, 2015, the disclosure of which is incorporated by reference in its entirety herein.

In another example, a detection and imaging device may include an optical system based on a bistatic electronically controlled notch absorber that absorbs radiation in the same wavelength range as the gas to be detected and imaged. Such a device alternately images the scene through the bistatic absorber in the notch and out-of notch wavelength ranges, respectively. The description and operation of such a detection and imaging device is disclosed in the applicants' commonly owned U.S. patent application, entitled “Infrared Detection and Imaging with No Moving Parts” (U.S. patent application Ser. No. 14/936,704), filed Nov. 10, 2015, the disclosure of which is incorporated by reference in its entirety herein.

As a result of the operation and components of the detection and imaging device 10, each pixel of the region of space in which the gas cloud 32 is detected can be imaged, and more precisely, the gas exit region 34 itself can be imaged along with the gas cloud 32. The detection and imaging device 10 also includes image acquisition electronics 110 electronically coupled to the detector array 102 for processing output from the detector array 102 in order to generate and record signals corresponding to the detector elements (i.e., scene pixels) for imaging the scene 30. The image acquisition electronics 110 includes electronic circuitry that produces corresponding pixel signals for each pixel associated with a detector element. As a result of the radiation being imaged on multiple detector elements, the image acquisition electronics 110 produces multiple corresponding pixel signals.

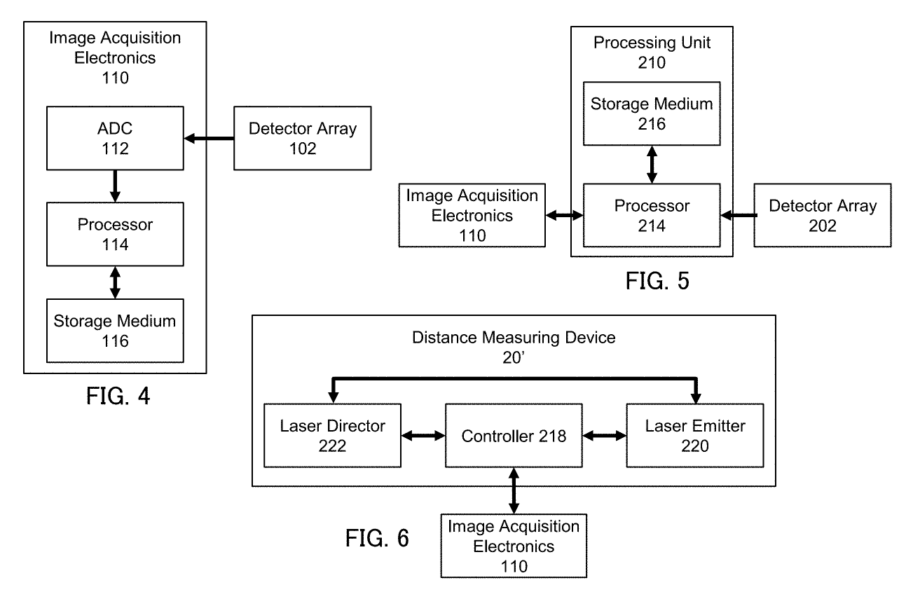

As shown in FIG. 4, the image acquisition electronics 110 includes an analog to digital conversion module (ADC) 112 electronically coupled to a processor 114. The processor 114 is coupled to a storage medium 116, such as a memory or the like. The ADC 112 converts analog voltage signals from the detector elements of the detector array 102 into digital signals. Note that certain types of detector arrays may provide digital data in the form of digital output signals to image acquisition electronics. As such, the ADC 112 may be excluded from the image acquisition electronics 110 when using detector arrays that provide digital output. The processor 114 can be any number of computer processors including, but not limited to, a microprocessor, an ASIC, a DSP, a state machine, and a microcontroller. Such processors include, or may be in communication with computer readable media, which stores program code or instruction sets that, when executed by the processor, cause the processor to perform actions. Types of computer readable media include, but are not limited to, electronic, optical, magnetic, or other storage or transmission devices capable of providing a processor with computer readable instructions. As should be apparent, all of the components of the image acquisition electronics 110 are connected or linked to each other (electronically) either directly or indirectly.

The processor 114 is configured to perform computations and algorithms for identifying a non-predetermined region of the scene 30 in which the gas cloud 32 is present. The non-predetermined region of the scene 30 also includes the gas exit region 34, or other non-gaseous item or object in the vicinity of the gas cloud 32, which a camera or laser from a laser range finder, or other similar optical device may focus on. The computations and algorithms are performed based on the digital signals received from the ADC 112 (or directly from the detector array for arrays that provide digital output). The processor 114 is also configured to perform computations and algorithms for measuring parameters of the gas cloud 32 based on the digital signals and the estimated distance L provided by the distance measuring device 20, as will be described in more detail below.

As mentioned above, the detection and imaging device 10 is operative to provide input to, and receive input from, the distance measuring device 20. Various embodiments of distance measuring devices in accordance with the system 1 of present disclosure will now be presented.

3a. Distance Measurement by Focus Adjustment:

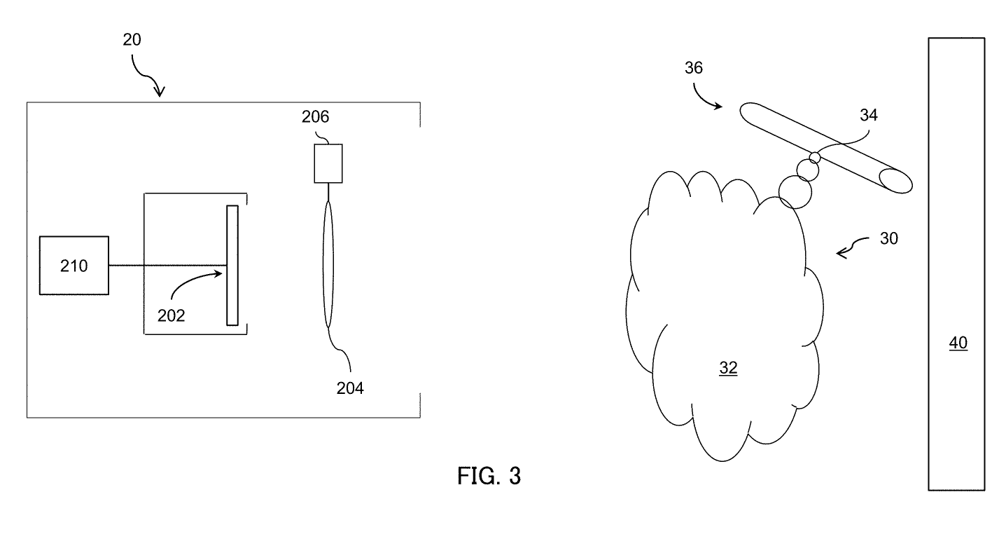

Refer now to FIG. 3, a schematic illustration of an embodiment of the distance measuring device 20. The distance measuring device 20 includes a detector array 202 and an optical collection system 204 positioned between the scene 30 and the detector array 202. The detector array 202 may be implemented as part of an infrared or visible camera system. The distance measuring device 20 is boresighted with the detection and imaging device 10, such that the distance measuring device 20 and the detection and imaging device 10 share a common optical axis, and preferably overlapping fields of view.

The optical collection system 204 is represented symbolically in FIG. 3 by a focusing lens, which may be a set of one or more lenses that is represented in FIG. 3 by a single lens. In a first non-limiting implementation, the distance measuring device 20 also includes a mechanism 206 for adjusting the focus of the focusing lens by, for example, adjusting the position of the focusing lens along the optical axis of the distance measuring device 20. The mechanism 206 may be implemented as, for example, a motor for automatically adjusting the focus of the focusing lens, or may alternatively be implemented as a mechanism for moving the focusing lens by manual actuation.

The optical collection system 204 (i.e., the focusing lens) is operative to image the same region of space as the detection and imaging device 10. The optical collection system 204 defines a FOV of the distance measuring device 20, and directs light (e.g., visible light) from the scene 30, within the defined FOV, onto the detector array 202 for forming an image of the scene 30 on the detector array 202. When the detector array 202 is implemented as part of a visible camera system, the formed image of the scene 30 is a non-infrared image. In such an implementation, the detector array 202 may be realized as an electronic image sensor, such as, for example a charge coupled device (CCD) or a CMOS sensor, which capture the scene image. As mentioned above, the FOVs of the devices 10 and 20 have at least partial overlap, and most preferably have identical FOVs.

The location of the gas exit region 34, or other appropriate object in the vicinity of the gas cloud 32, in the image of the non-predetermined region of the scene 30 identified by components of the image acquisition electronics 110 is provided to the distance measuring device 20. In other words, the scene pixels corresponding to the gas exit region 34, or other appropriate object in the vicinity of the cloud, are provided to the distance measuring device 20. The image acquisition electronics 110 can provide the above mentioned information to the measuring device 20 either manually or via a processing unit 210 of the distance measuring device 20 that is electronically coupled to the image acquisition electronics 110 via a communication bus or the like.

As shown in FIG. 5, the processing unit 210 preferably includes a processor 214 coupled to a storage medium 216, such as a memory or the like. Although not shown, the processing unit 210 may also include an ADC for converting analog voltage signals from the detector elements of the detector array 202 into digital signals and providing those signals to the processor 214. The processor 214 can be any number of computer processors including, but not limited to, a microprocessor, an ASIC, a DSP, a state machine, and a microcontroller. Such processors include, or may be in communication with computer readable media, which stores program code or instruction sets that, when executed by the processor, cause the processor to perform actions. Types of computer readable media include, but are not limited to, electronic, optical, magnetic, or other storage or transmission devices capable of providing a processor with computer readable instructions. As should be apparent, all of the components of the processing unit 210 are connected or linked to each other (electronically) either directly or indirectly.

In the first non-limiting implementation using the mechanism 206 for adjusting the focus of the focusing lens, the non-predetermined region of the scene 30 is focused on by adjusting the focus of the optical collection system 204 (i.e., the focusing lens) in the image of the scene formed on the detector array 202. The selection of the portion of imaged scene to be focused on may be selected manually, for example, by a human operator of the system 1 watching a display coupled to the image acquisition electronics 110 or processing unit 210 showing the scene imaged by the detection and imaging device 10 or the distance measuring device 20. Alternatively, the selection of the portion of the imaged scene to be focused on may be automatically selected by the processing unit 210 of the distance measuring device 20. The distance between the distance measuring device 20 and any portion of imaged scene to be focused on is preferably provided by a previously calibrated indication in the form of tick marks on the mechanism 206, or mechanical or digital encoding provided to the processing unit 210. This calibrated distance allows the system 1 to estimate the distance L between the system 1 and the gas exit region 34 or other appropriate object in the vicinity of the cloud, without a priori knowledge of the distance between the system 1 and the scene 30.

In an exemplary non-limiting illustration of the operation of the system 1 in accordance with the first non-limiting implementation, when the detection and imaging device 10 detects the position of the gas cloud 32 and the gas exit region 34, the position (i.e., location) of the gas exit region 34, or other object in the vicinity of the gas exit region 34, in the image of the scene 30 formed on the detector array 102 is provided to the distance measuring device 20 by the image acquisition electronics 110. The position (i.e., location) is provided in the form of the scene pixels that correspond to the gas exit region 34, or other object in the vicinity of the gas exit region 34, in the image formed on the detector array 102. The focusing lens position of the optical collection system 204 is adjusted until the provided position (e.g., the gas exit region 34) is in focus in the image formed on the detector array 202. Based on the adjusted focusing position of the optical collection system 204 (i.e., the focusing lens), the processing unit 210 estimates the distance L between the system 1 and the gas exit region 34. The estimated distance L is then used for measuring (i.e., calculating and estimating) parameters of the gas cloud 32. Such parameters include, for example, the path concentration of the gas cloud 32 in each pixel of the image, the gas cloud 32 column density or surface density, the amount of gas molecules present in each cloud column and in the cloud itself, the flow rate of the gas cloud 32, or any other relevant information which can be determined based on the path concentration and the estimated distance L.

The estimated distance L may be provided by the processing unit 210 to components of the image acquisition electronics 110 (e.g., the processor 114) to perform the above mentioned gas cloud parameter measurements. Alternatively, the processing unit 210 may perform the above mentioned gas cloud parameter measurements based on the calculated estimated distance L and detection and imaging information provided to the processing unit 210 by the image acquisition electronics 110. It is noted that in either of the above mentioned alternatives, the image processing electronics 110 and the processing unit 210 are able to share information pertaining to the scene which is derived from performed computations. As such, performance of the detection, imaging and measurement functions may be divided between the processors 114 and 214.

In a second non-limiting implementation, the focus of the focusing lens is fixed at a permanent distance, such as, for example, infinity or some other fixed distance, and the mechanism 206 is not present. In an exemplary non-limiting illustration of the operation of the system 1 in accordance with the second non-limiting implementation, the amount of distortion, deviation from sharp focus and/or blur of the image in the region of the image surrounding the gas exit region 34 is/are used to determine the amount of deviation from the optimal focus lens position. This latter deviation of focus position and amount of blur is/are used as input to computations and algorithms performed by the processor 214 which translates such input into an estimate of the distance L between the system 1 and the gas exit region 34.

It is noted that the processing unit 210 and the image acquisition electronics 110 may be implemented using a single processing system with one or more processors in order to provide detecting, imaging and measurement functionality in a single processing device.

Through mathematical modeling and proof of feasibility, distances of up to 50 meters between the system 1 and the gas exit region 34 can be measured. It is noted that proof of feasibility is performed by calculations of lens position sensitivity and other image data resulting from image processing, as a function of the distance to the gas exit region and the allowed error tolerance in the distance calculation. As a non-limiting example, a simplified case of a single lens using the paraxial approximation will now be presented. From geometrical optics the paraxial formula is given by:

l/s₁+l/s₂=l/ƒ (11)

and by differentiation, in first order approximation for small distance changes ds₁ and ds₂:

ds₁=−ƒ²·ds₂/(s₂−ƒ)² (12)

where ƒ is the focal length of the optical collection system 204 (i.e., the focusing lens), s₁ is the distance between the focusing lens and the image plane on the detector array 202, and s₂ is the distance between the focusing lens and the scene to be imaged (e.g., the gas cloud 32 and the gas exit region 34). The distance s₂ is approximately equal to the desired estimated distance L discussed above. The differential value ds₂ is the error range of the distance measurement from the optical collection system 204 to the gas leak. The differential value ds₁ is the sensitivity of the focus lens position of the optical collection system 204 to the error range ds₂ between the optical collection system 204 and the gas leak. Accordingly, ds₁ is the distance the focusing lens must be moved by, in order for the image to remain in focus after the scene distance is changed by an amount ds₂. The negative sign in equation (12) indicates that a positive distance difference ds₂ causes the paraxial lens to move closer to the plane of the detector array 202 to maintain focus.

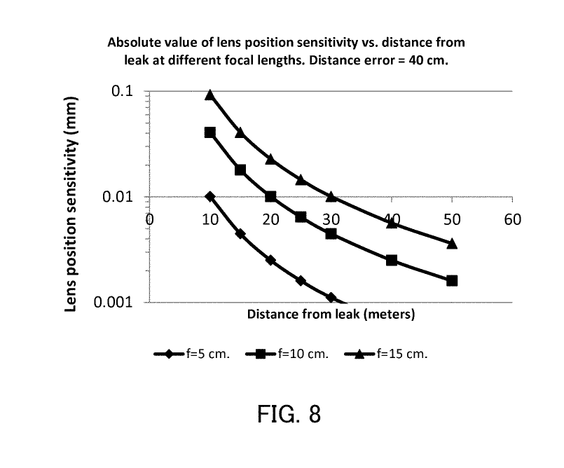

FIG. 8 shows the sensitivity of s₁ (the absolute value |ds₁|) as function of s₂ (or equivalently the estimated distance L) for different values of ƒ and a distance error of ds₂=40 cm as an example, in a first order approximation. As should be apparent, the magnitude of |ds₁| in the whole range from 10 to 50 meters is well within the optics design capability of an infrared or visible camera system. It can also be seen from FIG. 8 that for a given distance difference ds₂, the sensitivity is higher (larger values of |ds₁|) for smaller distances and longer focal lengths. It can also be seen from equation (12) that the relationship between ds₁ and ds₂ has the result that a larger tolerance of the distance s₂ measurement allows for looser control and knowledge of the lens position.

Accordingly, the sensitivity ds₁ should remain larger than the depth of focus of the optical collection system 204, otherwise the focus lens position of the optical collection system 204 may not be used for the leak distance estimate within the given tolerance. In fact, if different distances larger than the tolerance are all within the depth of focus, they cannot be distinguished by focal sharpness. To exemplify how a system design might be implemented, an example of a diffraction limited system in the visible range is presented. Consider as an example the value of ƒ=5 cm and a focusing lens diameter D=5 cm. Such values result in an optical f-number (ƒ#) of 1. In accordance with the sensitivity information shown in FIG. 8, the maximum measurable distance L is 30 meters. The depth of focus d due to diffraction is approximated by:

d≈2*λη#² (13)

where λ is the wavelength of light. Considering the example of visible light, a wavelength of 0.5μ is used. Accordingly, equation (13) results in a depth of focus d of 1μ for ƒ#=1.

This shows that, since the curve in FIG. 8 for η=5 cm is always above 1μ, a consistent and operable situation is present. As such, using a diffraction limited system at ƒ#=1 and visible wavelengths, a distance measurement of up to 30 meters with an error tolerance of 40 cm can be achieved by the system 1.

3b. Distance Measurement by Laser:

According to the discussion above, the range of the distance measurement depends on the design of the optical collection system 204. As such, alternative distance measurement techniques may be more applicable in certain instances. According to an embodiment of a distance measuring device 20′, the distance measurement is accomplished by using a laser range finder type of device.

Refer now to FIG. 6, a block diagram of an embodiment of the distance measuring device 20′. The distance measuring device 20′ includes a controller 218, a laser emitter 220 for emitting a laser pulse, and a laser director mechanism 222 for directing the laser pulse toward a specified position. The specified position translates to a pointing direction to which the laser emitter 220 can direct one or more laser pulses. The pointing direction is preferably adjusted by the laser director mechanism 222 for directing the laser pulse toward the gas exit region 34. The laser director mechanism 222 may be implemented as a servo mechanism that is capable of moving the laser emitter 220 about a three dimensional axis. Alternatively, the laser director mechanism 222 may be implemented as a series of moveable reflectors for reflecting the laser pulse toward a desired location.

Preferably the controller 218 is configured to actuate both the laser director mechanism 222 to direct the laser pulse to the desired location, and the laser emitter 220 to emit one or more laser pulses.

In the embodiment of the distance measuring device 20′ of FIG. 6, the controller 218 is preferably coupled to the image acquisition electronics 110 (e.g., the processor 114) via a communication bus or the like.

Similar to as discussed with reference to the distance measuring device 20 of FIG. 3, the non-predetermined region of the scene 30 identified by components of the image acquisition electronics 110 is provided to the distance measuring device 20, either manually or preferably via the controller 218 that is electronically coupled to the image acquisition electronics 110. As such, the position in the image of the scene 30 formed on the detector array 102 is provided to the distance measuring device 20 as an output of the image acquisition electronics 110. As previously discussed, the detection and imaging device 10 images each pixel of the region of space in which the gas cloud 32 is detected, which includes imaging the gas exit region 34 itself. As such, the position of the gas exit region 34 in the image of the scene 30 formed on the detector array 102 is provided to the distance measuring device 20′ as an output of the image acquisition electronics 110.

In an exemplary non-limiting illustration of the operation of the system 1 in accordance with the distance measuring device 20′, when the detection and imaging device 10 detects the position of the gas cloud 32 and the gas exit region 34, the position of the gas exit region 34 in the image of the scene 30 formed on the detector array 102 is automatically provided to the controller 218 by the image acquisition electronics 110. In addition to providing the position (i.e., pointing direction) to the controller 218, the image acquisition electronics 110, and more specifically the processor 114, provides a command (via datalink or the like) to the controller 218 to actuate both the laser director mechanism 222 to direct the laser pulse to the desired location (e.g., the gas exit region 34), and to actuate the laser emitter 220 to emit the one or more laser pulses. Alternatively, the pointing of the laser emitter 220 toward gas exit region 34, and the actuation of the laser emitter 220 to emit the one or more laser pulses may be performed manually by an operator of the system 1.

In a non-limiting implementation, the laser emitter 220 may be implemented as, for example, a commercially available laser rangefinder, such as, for example, the model Leica DISTO D2 Rangefinder Laser Distance Meter, which can measure distances of up to 60 meters with an accuracy within 1.5 mm. Such laser type rangefinders estimate distance by comparing the characteristics of the emitted laser pulse with characteristics of a reflected laser pulse.

Similar to as discussed with reference to the distance measuring device 20 of FIG. 3, the calculated estimated distance L may be provided by the controller 218 to components the image acquisition electronics 110 (e.g., the processor 114) for measuring various parameters of the gas cloud 32. Alternatively, controller 218 may perform the above mentioned gas cloud parameter measurements based on the calculated estimated distance L and detection and imaging information provided to the controller 218 by the image acquisition electronics 110. It is noted that in either of the above mentioned alternatives, the image processing electronics 110 and the controller 218 are able to share information pertaining to the scene which is derived from performed computations. As such, performance of the detection, imaging and measurement functions may be divided between the processor 114 and the controller 218.

Note that in the embodiment of the distance measuring device 20′, the laser emitter 220 may be configured to emit laser pulses at wavelengths that are not absorbed by the gas in question, allowing the laser pulses to reflect off of the pipe 36, and more specifically, off of the gas exit region 34.

The controller 218 may be implanted as any number of computer processors including, but not limited to, a microprocessor, an ASIC, a DSP, a state machine, and a microcontroller. Such processors include, or may be in communication with computer readable media, which stores program code or instruction sets that, when executed by the processor, cause the processor to perform actions. Types of computer readable media include, but are not limited to, electronic, optical, magnetic, or other storage or transmission devices capable of providing a processor with computer readable instructions. As should be apparent, all of the components of the distance measuring device 20′ are connected or linked to each other (electronically) either directly or indirectly.

It is also noted that the controller 218 and the image acquisition electronics 110 may be implemented using a single processing system with one or more processors in order to provide detecting, imaging and measurement functionality in a single processing device.

3c. Distance Measurement, Detection and Imaging by the Same Camera System:

Although the system 1 described thus far has pertained to separate devices for performing the functions of: 1) distance measurement and gas parameter measurement and 2) detection, imaging, and gas parameter measurement (preferably within a common casing or housing), other embodiments are possible in which all of the above detection, imaging, and measurement functionality is performed with a single set of optics and a single detector array.

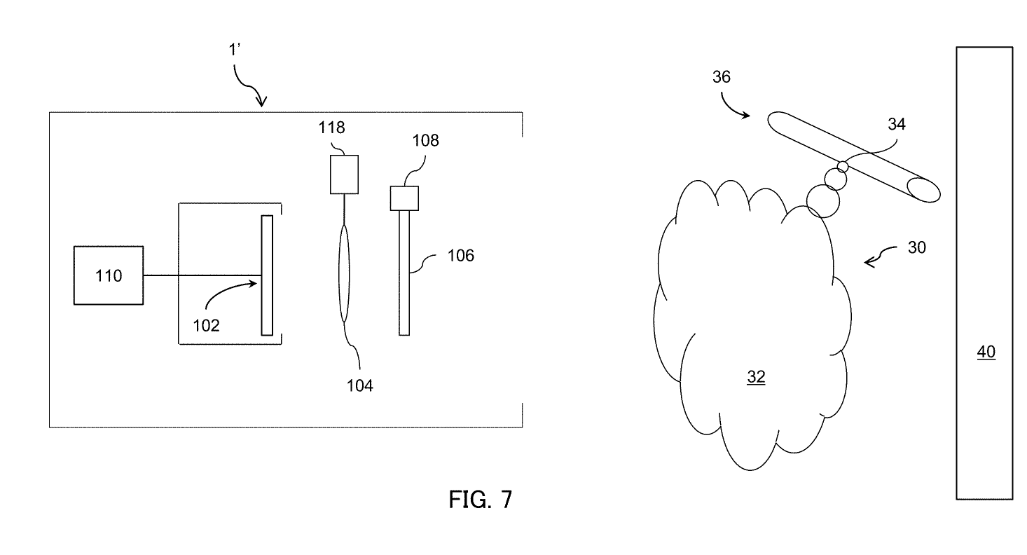

Refer now to FIG. 7, a schematic illustration of such an embodiment of a system 1′ of the present disclosure. The system 1′ is similar to the previously described embodiments of the system 1 in that several of the components of the detection and imaging device 10 are common to both systems (e.g., the detector array 102, the image forming optic 104, the filtering arrangement 106, the mechanism 108, and the image acquisition electronics 110). Note that the description herein of the structure and operation of the detector array 102, the image forming optic 104, the filtering arrangement 106, the mechanism 108, and the image acquisition electronics 110 of the system 1′ is generally similar to that of the detection and imaging device 10 unless expressly stated otherwise, and will be understood by analogy thereto.

One key feature of the components of the system 1′ that is different from the detection and imaging device 10 is the adjustable focus of the image forming optic 104. The system 1′ also includes a mechanism 118 for adjusting the focus of the image forming optic 104 by, for example, adjusting the position of the image forming optic 104 the optical axis of the system 1′. The mechanism 118 may be implemented as, for example, a motor for automatically adjusting the focus of the focusing lens, or may alternatively be implemented as a mechanism for moving the focusing lens by manual human actuation. The mechanism 118 may be functionally coupled to the image acquisition electronics 110 to allow for automatic focus adjustment of the image forming optic 104. Accordingly, components of the image acquisition electronics 110 (e.g., the processor 114) are configured to actuate the mechanism 118 to adjust the focus of the image forming optic 104 until the gas exit region 34 is in focus in the image formed on the detector array 102. Based on the adjusted focusing position of the image forming optic 104, the image acquisition electronics 110 estimates the distance L between the system 1′ and the gas exit region 34.

Alternatively, the mechanism 118 may be manually actuated by a human operator to adjust the focus of the image forming optic 104 until the gas exit region 34 is in focus in the image formed on the detector array 102.

It is noted that in the above described embodiment of the system 1′, the sensitivity of the detector array 102 to infrared radiation, and the longer required focus depth of the image forming optic 104 (due to longer wavelengths of infrared light), may result in unwanted side effects. Firstly, the distance measurements may have larger error tolerances which can negatively impact the calculation of the path concentration of the gas cloud 32 and the flow rate of the gas cloud 32. Secondly, in order to achieve the necessary focus depth, optics with longer focal lengths may be required.

Implementation of the system and/or device of embodiments of the invention can involve performing or completing selected tasks manually, automatically, or a combination thereof. Moreover, according to actual instrumentation and equipment of embodiments of the system and/or device of the invention, several selected tasks could be implemented by hardware, by software or by firmware or by a combination thereof using an operating system.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for analyzing radiation from a scene that includes a gas cloud having absorption characteristics in a corresponding wavelength band, the system comprising:
an optical device for detecting and imaging the radiation from the scene, the optical device having a first field of view and including a first detector having a plurality of detector elements, each detector element associated with a corresponding scene pixel, the optical device configured to:
form an image of the scene on the first detector,
produce a pixel signal from each respective detector element, each of the pixel signals including information associated with the absorption of radiation in the wavelength band of the gas cloud, and
identify a non-predetermined region of the scene within the first field of view in which the gas cloud is present based on the produced pixel signals; and
a distance measuring device operative to receive input from the optical device, the distance measuring device including a second detector of the scene and an optical collection system that includes at least one lens for forming an image of the scene on the second detector, the optical collection system having a second field of view having at least partial overlap with the first field of view, the distance measuring device configured to:
receive the identified region of the scene from the optical device, and
determine a distance between the identified region of the scene and the system based on the focus of the at least one lens relative to the identified region of the scene in the image formed on the second detector by the optical collection system.

2. The system of claim 1, wherein the gas cloud emanates from a source location, and the identified region of the scene includes at least one of the source location or an object in a vicinity of the source location.

3. The system of claim 1, wherein the distance measuring device further includes a processing unit for determining the distance between the identified region of the scene and the system.

4. The system of claim 1, wherein the optical device further includes:
an image forming optical component for forming an image of the scene on the elements of the first detector; and
electronic circuitry electronically coupled to the first detector, the electronic circuitry configured to:
produce the pixel signals from each respective detector element,
identify the region of the scene in which the gas cloud is present, and
provide the identified region of the scene to the distance measuring device.

5. The system of claim 4, wherein the electronic circuitry is further configured to:
receive the determined distance as input from the distance measuring device.

6. The system of claim 4, wherein the distance measuring device further includes a processing unit for determining the distance between the identified region of the scene and the system, and at least one of the processing unit or the electronic circuitry is configured to determine a measurement parameter of the gas cloud based on the determined distance.

7. The system of claim 6, wherein the measurement parameter is selected from the group consisting of: a path concentration of the gas cloud in each pixel of the image formed on the first detector, a column density of the gas cloud, a surface density of the gas cloud, an amount of gas molecules that are present in each column of the gas cloud, an amount of gas molecules present in the gas cloud, a flow rate of the gas cloud, and a combination thereof.

8. The system of claim 6, wherein the processing unit is configured to:
provide the determined distance to the electronic circuitry.

9. The system of claim 6, wherein the processing unit and the image acquisition electronics are implemented as a single processing system having at least one processor.

10. The system of claim 4, wherein the second detector is positioned along the optical axis of the image forming optical component.

11. The system of claim 1, wherein the at least one lens has an adjustable focus, and the determined distance is based on at least one of the amount of adjusted focus required to bring the identified region of the scene into focus, or the position of the focusing lens when the scene is in focus.

12. The system of claim 11, further comprising:
a mechanism for adjusting the focus of the at least one lens.

13. The system of claim 1, wherein the at least one lens is permanently focused at a fixed distance, and the determined distance is based in part on each of the fixed distance and the amount of distortion and/or image blur in the identified region of the scene.

14. The system of claim 1, further comprising:
a filtering arrangement including a filter associated with the corresponding wavelength band.

15. The system of claim 14, wherein the first detector is sensitive to radiation in a plurality of wavelength bands, and the filtering arrangement includes a plurality of filters, each of the filters being associated with a different wavelength band.

16. The system of claim 15, further comprising:
a mechanism operative to alternately and reversibly position each of the filters at a focal plane between the scene and the first detector.

17. The system of claim 1, wherein the optical device and the distance measuring device are retained within a common housing.

18. A system for analyzing radiation from a scene that includes a gas cloud emanating from a source location, the emanating gas cloud having absorption characteristics in a corresponding wavelength band, the system comprising:
a detector of the radiation from the scene, the detector including a plurality of detector elements, each detector element associated with a corresponding scene pixel;
an image forming optical component for forming an image of the gas cloud on the elements of the detector;
a distance measuring device including a laser emitter and a controller for actuating the laser emitter to emit at least one laser pulse; and
electronic circuitry electronically coupled to the detector and operative to provide input to the laser unit, the electronic circuitry configured to:
produce a pixel signal from each respective detector element, each of the pixel signals including information associated with the absorption of radiation in the wavelength band of the gas cloud,
identify a region of the scene for which the gas cloud is present based on the produced pixel signals, the identified region of the scene including the source location, and
provide to the distance measuring device a pointing direction for directing the at least one laser pulse toward the source location to determine a distance between the identified region of the scene and the system.

19. The system of claim 18, wherein the scene is selected from a non-predetermined geographic location within a field of view defined by the image forming optical component.

20. The system of claim 18, further comprising:
a mechanism functionally associated with the controller configured to direct the at least one laser pulse.

21. The system of claim 20, wherein the electronic circuitry is operatively coupled to the controller and is further configured to:
provide a command to the controller to actuate the mechanism to direct the at least one laser pulse toward the identified region of the scene.

22. The system of claim 18, further comprising:
a filtering arrangement including a filter associated with the corresponding wavelength band.

23. The system of claim 22, wherein the detector is sensitive to radiation in a plurality of wavelength bands, and the filtering arrangement includes a plurality of filters, each of the filters being associated with a different wavelength band.

24. The system of claim 23, further comprising:
a mechanism operative to alternately and reversibly position each of the filters at a focal plane between the scene and the detector.

25. The system of claim 18, wherein the image acquisition electronics and the controller are implemented as a single processing system having at least one processor.

26. The system of claim 18, wherein the detector, the image forming optical component, the electronic circuitry, and the distance measuring device are retained within a common housing.

27. A device for analyzing radiation from a scene that includes a gas cloud having absorption characteristics in a corresponding wavelength band, the device comprising:
a detector of the radiation from the scene, the detector including a plurality of detector elements, each detector element associated with a corresponding scene pixel;
a filtering arrangement including a filter associated with the corresponding wavelength band;
an optical collection system including at least one lens having adjustable focus for forming an image of the scene on the elements of the detector; and
electronic circuitry electronically coupled to the detector, the electronic circuitry configured to:
produce a pixel signal from each respective detector element, each of the pixel signals including information associated with the absorption of radiation in the wavelength band of the gas cloud,
identify a non-predetermined region of the scene within a field of view defined by the optical collection system in which the gas cloud is present based on the produced pixel signals, and
determine a distance between the identified region of the scene and the device based on the amount of adjusted focus of the at least one lens required to bring the identified region of the formed image of the scene into focus.

28. The device of claim 27, further comprising:
a mechanism for adjusting the focus of the at least one lens, and wherein the electronic circuitry is further configured to actuate the mechanism to adjust the focus of the at least one lens.

29. The device of claim 27, wherein the gas cloud emanates from a source location, and the identified region of the scene includes the source location.

30. (canceled)
